(19) United States
(12) Patent Application Publication
(10) Pub. No.: US 2024/0378738 A1
(43) Pub. Date: Nov. 14, 2024

(54) SYSTEM FOR SPATIOTEMPORAL AUDIOVISUAL CAPTURE

(71) Applicant: Brown University, Providence, RI (US)

(72) Inventor: Srinath SRIDHAR, Providence, RI (US)

(21) Appl. No.: 18/657,695

(22) Filed: May 7, 2024

Related U.S. Application Data
(60) Provisional application No. 63/501,644, filed on May 11, 2023.

(51) Int. Cl. G06T 7/593

(52) U.S. Cl. CPC G06T 7/593; G06T 2207/10024; G06T 2207/10048

(57) ABSTRACT

A system for 3D and 4D capture comprises a stage including a multi-sided stage frame and frame defining a stage capture volume with a plurality of first sensor modules supported by frame. Each first sensor modules include a module frame with a translucent front panel attached to which is mounted an RGB camera, a depth camera, an IR camera and a microphone, and a back panel attached to the opposite side of the module frame from the front panel, the back panel supporting a lighting array. The stage further comprises a plurality of second sensor modules mounted that include an elongated frame having a translucent elongated front panel attached to said front side of said elongated frame, that supports at least one RGB camera.

### CROSS-REFERENCE TO RELATED APPLICATIONS

This application claims benefit under 35 U.S.C. § 119 (e) of U.S. Provisional Patent Application No. 63/501,644 filed May 11, 2023, the contents of which are incorporated herein by reference in their entirety.

### BACKGROUND

### Field

The present disclosure relates generally to 4-Dimensional (4D) capture of audiovisual data, and, more particularly, to 3D and 4D capture of interactions between humans or robots with objects.

### Description of the Problem and Related Art

4D motion capture is a technique used to capture and analyze movement in four dimensions: three spatial dimensions (length, width, and height) and time (duration). This technology is often used in animation, biomechanics, sports analysis, and other fields where precise movement tracking is required. This data can then be used for various purposes, such as animating a character in a movie or analyzing an athlete's performance. These markers reflect light emitted by cameras positioned around the subject, allowing the system to track the movement of each marker in 3D space.

4D motion capture is accomplished using a combination of hardware and software. Multiple High-speed cameras are positioned around the capture area to capture the movement in a capture volume. The number of cameras used can vary depending on the requirements of the capture. Generally, more cameras provide better coverage and accuracy but also increase the complexity and cost of the setup. Cameras are placed around the capture area to ensure that they can capture the movement of the subject from multiple angles. The exact placement of cameras depends on factors such as the size of the capture area and the desired coverage. Camera settings, such as frame rate, exposure, and resolution, are adjusted based on the requirements of the capture. Higher frame rates are typically used for capturing fast movements, while higher resolutions can provide more detailed images. To ensure complete coverage of the subject from all angles, the camera setup often includes overlap between the fields of view of adjacent cameras. This overlap helps to ensure that there are no gaps in the captured data.

To ensure accurate reconstruction of movement, all cameras must be synchronized so that they capture frames at the same time. This synchronization is usually achieved using hardware triggers or software synchronization tools.

In some systems, reflective markers are placed on the subject's body at specific anatomical landmarks and joints. The number and placement of markers can vary depending on the specific requirements of the capture. In other systems, 4D data capture may be achieved without markers using depth sensors and/or accelerometers. The cameras and other sensors must be synchronized to ensure that they capture subject(s) from multiple angles simultaneously. Additionally, the system must be calibrated to ensure accuracy. Then, the subject performs the desired movements while being recorded by the cameras. The cameras capture the movement in three dimensions (X, Y, Z) over time.

The captured data is processed by specialized software to reconstruct the movement of the subject in 3D space over time. Where the system uses markers, each marker must be tracked. In all systems, accounting for camera angles is crucial because each camera captures the movement from a different perspective, and these perspectives need to be combined to create a coherent representation of the motion. Data processing algorithms typically use triangulation techniques to calculate the 3D positions of the reflective markers based on their images captured by multiple cameras. The known positions and orientations of the cameras (i.e., their angles relative to the subject) are used in these calculations to accurately determine the 3D positions of the markers. Consequently, this increases the complexity, and, therefore, the cost of 4D capture systems.

Meanwhile, generative AI systems have seen a rapid rise in capabilities in the last few years. Systems like ChatGPT and StableDiffusion can now generate text and images almost indistinguishable from those produced by humans. Despite the progress, however, these systems lack physical intelligence—the human-like ability to skillfully interact with and shape environments using bodies and hands. Digitizing human physical intelligence is a challenging problem but could enable us to build robots with transformative physical capabilities and deepen our understanding of human motor cognition.

What is needed is physically intelligent AI systems that learn by visually observing everyday human interactions. Current AI models learn from large-scale text and image data on the internet, but physical interaction data is not easily available. Interaction videos exist on the internet (e.g. on YouTube), but these are not diverse enough and are hard to automatically parse as they lack multiple cameras that provide 3D cues about physical interactions (e.g. contact).

While current AI models are trained on large-scale text and image data on the internet, no such data exists for learning physical interactions. Monocular (single view) community videos (e.g. YouTube) could be used to address this limitation, but they are hard to automatically parse as they lack multiple views containing important 3D cues about physical interactions (e.g., contact). Building multi-camera systems for panoptic capture (using tens or hundreds of cameras) is a well-studied topic. But these systems have remained expensive ($200 k to $2M+), bulky, constrained to lab settings, and hard to calibrate and synchronize.

The proposed invention is a 50× cheaper, modular, and wireless multi-camera platform for panoptic sensing of human interactions to help build physically intelligent AI systems enabling ubiquitous multi-camera capture of everyday interactions at previously unseen scales and enable new research in the digitization of human physical intelligence, animal behavior, and the physical world.

### SUMMARY

For purposes of summary, certain aspects, advantages, and novel features are described herein. It is to be understood that not necessarily all such advantages may be achieved in accordance with any one particular embodiment. Thus, the apparatuses or methods claimed may be embodied or carried out in a manner that achieves or optimizes one advantage or group of advantages as taught herein without necessarily achieving other advantages as may be taught or suggested herein.

In a first aspect, a system for 4D capture comprises a stage including a multi-sided stage frame and frame defining a stage capture volume with a plurality of first sensor modules supported by frame. Each first sensor modules include a module frame with a translucent front panel attached to which is mounted an RGB camera, a depth camera, an IR camera and a microphone, and a back panel attached to the opposite side of the module frame from the front panel, the back panel supporting a lighting array. The stage further comprises a plurality of second sensor modules mounted that include an elongated frame having a translucent elongated front panel attached to said front side of said elongated frame, that supports at least one RGB camera.

### BRIEF DESCRIPTION OF THE DRAWINGS

The system is described with reference to the accompanying drawings. In the drawings, like reference numbers indicate identical or functionally similar elements. Additionally, the left-most digit(s) of a reference number identifies the drawing in which the reference number first appears.

FIGS. 1A through 1C show an exemplary transportable stage according to a first embodiment;

FIG. 2 is an exploded view of the support structure for a 3D/4D capture module, or “brick”;

FIG. 3 is an exploded view of a square brick showing how sensors and lighting are mounted;

FIGS. 4A & 4B show a front panel and a back panel of an elongated brick;

FIGS. 5A & 5B illustrate an exemplary arrangement for bricks within the sides of the stage;

FIG. 6 is a graphic illustrating an exemplary algorithm for synchronization of cameras in the system; and

FIG. 7 depicts an exemplary computer system.

### DETAILED DESCRIPTION

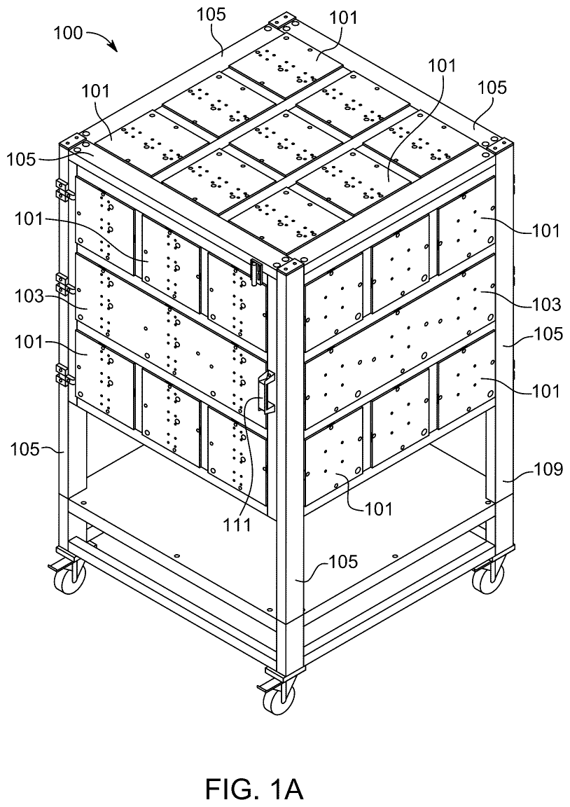

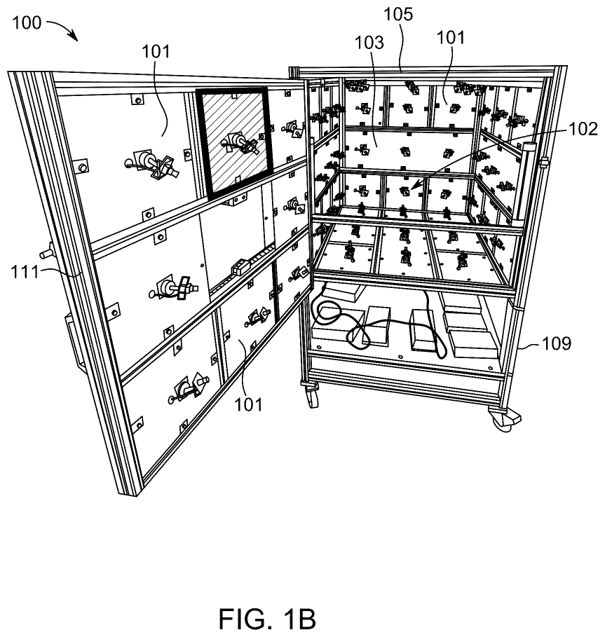

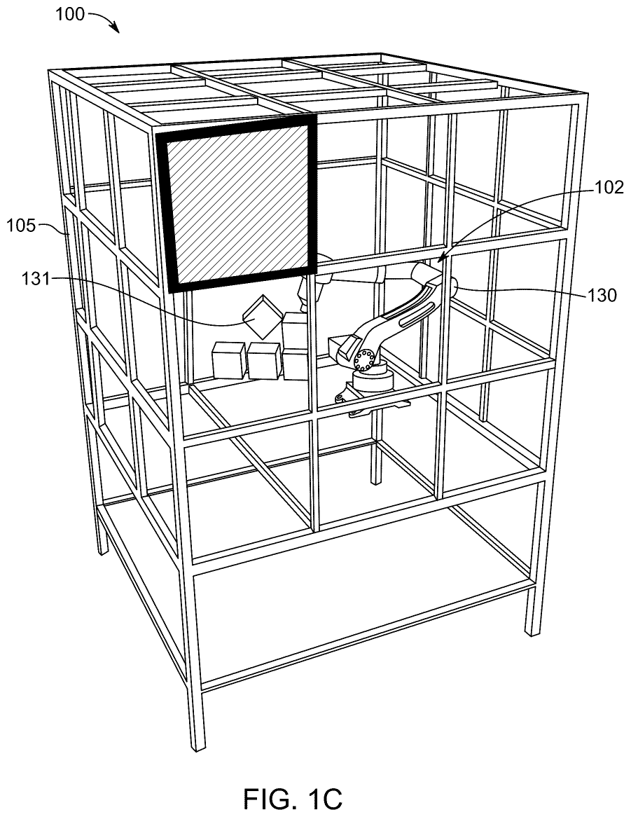

The various embodiments of the system and their advantages are best understood by referring to FIGS. 1 through 7 of the drawings. The elements of the drawings are not necessarily to scale, emphasis instead being placed upon clearly illustrating the novel features and principles of operation. Throughout the drawings, like numerals are used for like and corresponding parts of the various drawings.

Furthermore, reference in the specification to “an embodiment,” “one embodiment,” “various embodiments,” or any variant thereof means that a particular feature or aspect described in conjunction with the particular embodiment is included in at least one embodiment. Thus, the appearance of the phrases “in one embodiment,” “in another embodiment,” or variations thereof in various places throughout the specification are not necessarily all referring to its respective embodiment.

FIGS. 1A through 1C illustrate an exemplary embodiment of a 3D/4D capture stage 100, which, in this embodiment is transportable. Stage 100 is supported by a rolling table 109. Stage 100 may be a cube shape, or other rectangular solid, comprising six sides, each side being composed of capture modules, which may be referred to herein as “bricks,” 101, 103 mounted in a cubed frame 105. Stage 100 defines a chamber within the walls which is the capture volume 102. Access to capture volume 102 is through one side of the cube that is fashioned into a door 111 which is hingedly connected to frame 105. Within capture volume 102, there may be an actor, which in this example is a robotic arm 130, configured to interact with objects 131. Using the components of capture modules 101, 103 described in detail hereafter, data representing interaction between the arm 130 and the objects 131 may be recorded in X, Y, and Z dimensions over time. It will be appreciated that the structures defined herein may be used to record data of human hand interaction with objects as well. Such data may be used in machine learning applications for rendering human-like movement in computer graphics and robotics.

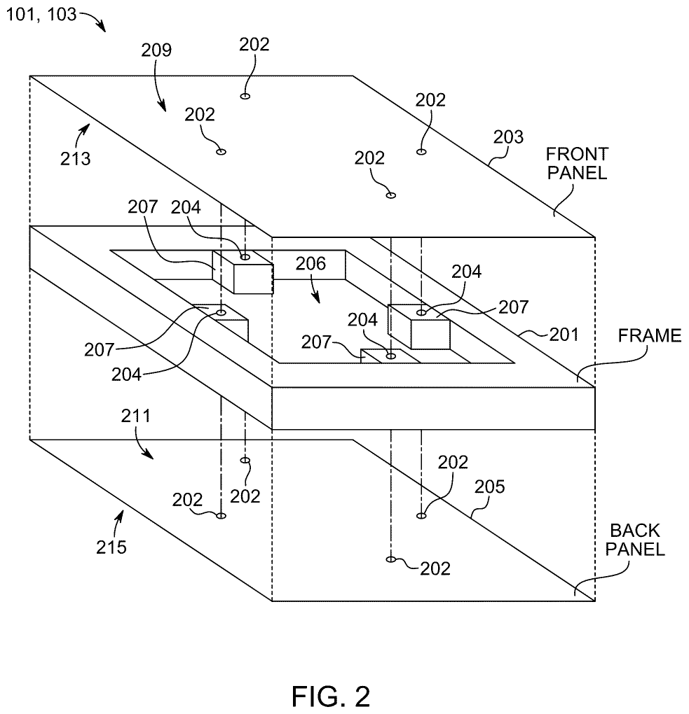

FIG. 2 is an exploded view of support structure for an exemplary brick 101, 103 comprising a square or rectangular frame 201 which defines an inward space 206 and which provides attachment support for a front panel 203 and a back panel 205. For purposes of orientation, the term, “front,” should be understood as oriented facing the capture volume 102 defined by stage 100, and the term, “back,” should be understood as oriented toward the outside of stage 100. Consequently, front panel 203 has an inward facing surface 209 and an outward facing surface 213, and back panel 205 has an inward facing surface 211 and an outward facing surface 215. Further, front panel 203 is composed of a translucent material, while back panel 205 may be of translucent or opaque material. A plurality of apertures 202 is defined in each panel 203, 205 for receiving fasteners (not shown) for attaching panels 203, 205 to frame 201 via corresponding holes 204 defined in flanges 207 that extend inward from the sides of frame 201.

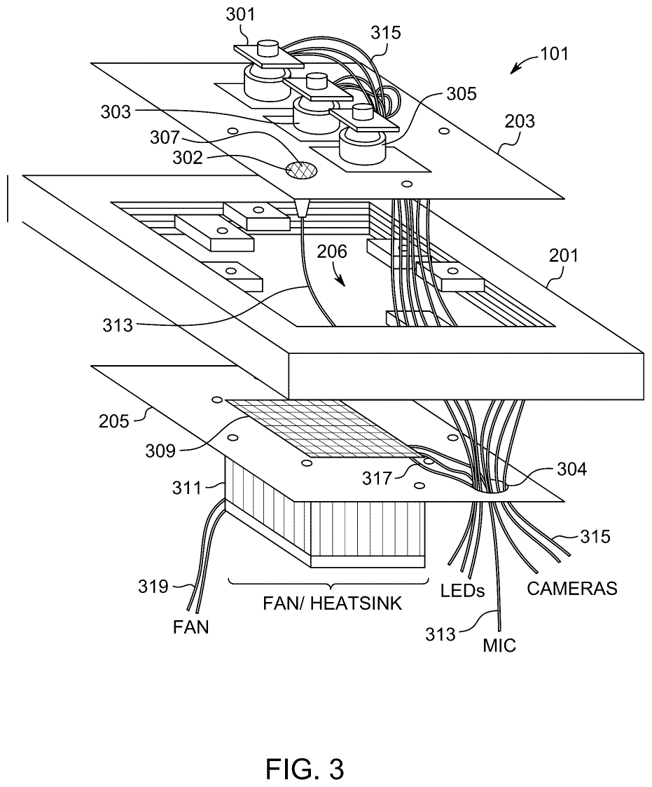

Referring now to FIG. 3, the construction of a square brick 101 is depicted where front panel 203 provides mounting support for three visual sensors, a depth camera 301, a red-green-blue (RGB) camera 303, and an infrared (IR) camera 305, all of which are oriented on the front panel 203 inward facing surface 209 to point toward the interior of stage capture volume 102. A microphone 307 is also mounted to front panel 203 inward facing surface 209 through aperture 302 defined therein. On the inward facing surface 211 of back panel 205, an array of LED's 309 is mounted. Array 309 is cooled by fan/heat sink 311 that is mounted to the outward surface 215 of back panel 205 and receiving power from fan wiring 319. Back panel 205 also includes a hole 304 for receiving wiring for the cameras (315), microphone 313, and LED array power and control 317. LED parameters that can be controlled are light intensity, density and color. Camera wiring 315 comprises both power supply and data transfer. This may be affected as power-over-Ethernet (POE) using a single cable to reduce complexity. Alternatively, wiring 315 may be separate cabling for power and data transfer.

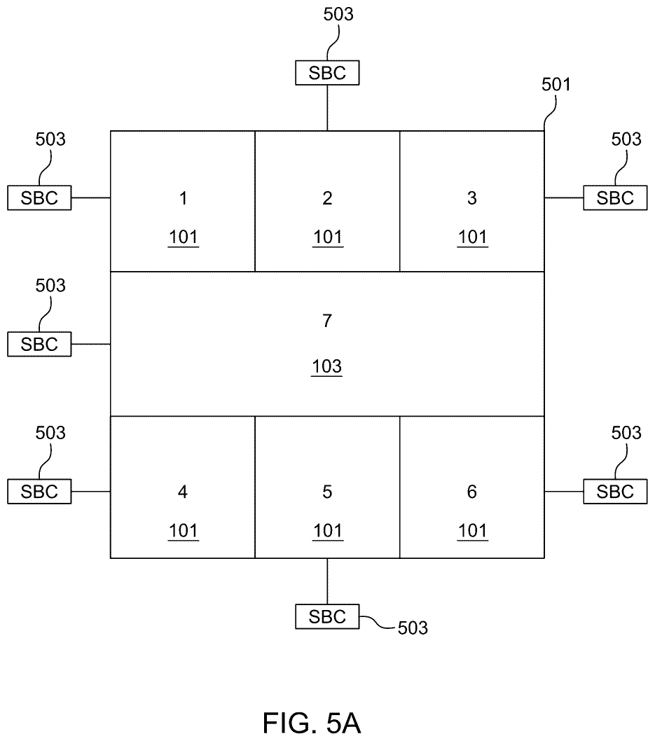

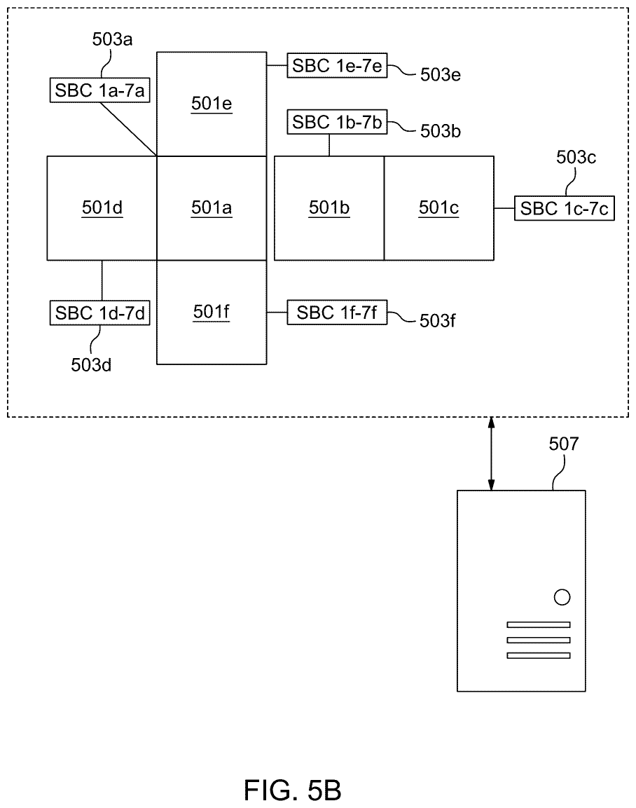

Preferably, RGB camera 303 has a high frame rate of at least 70 FPS, and a resolution of at least 720p. A non-limiting example of the depth camera 301 is the Intel® RealSense™ D435i. The cameras 301, 303, 305 and microphone 307 may be controlled by a single board computer (SBC) (FIG. 5A: 503). SBC 503 may be, for example, an Odroid N2+. In one embodiment, one SBC 503 is allocated to each brick 101, 103.

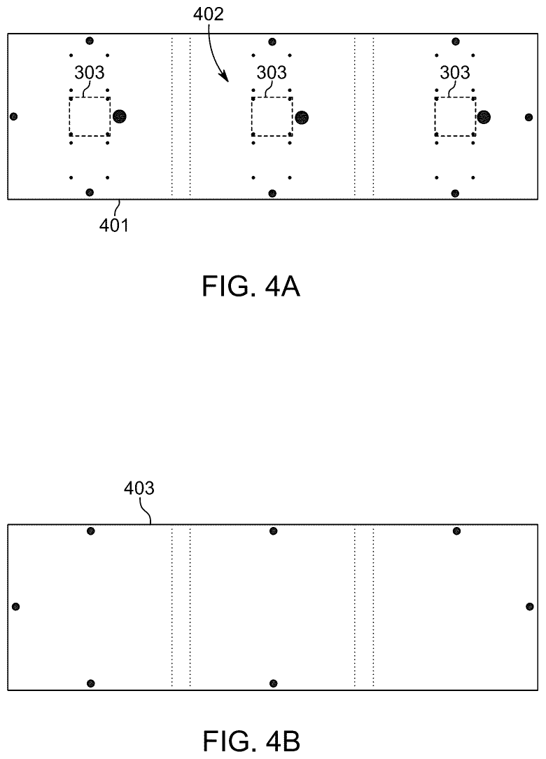

FIG. 4A shows an elongated front panel 401 for a rectangular brick 103 having an inward facing surface 402. An array of RGB cameras 303 is mounted to elongated front panel 401 oriented to point toward the interior of the capture volume 102. As with square brick 101, front panel 401 is formed from a translucent material. An elongated back panel 403 which may be formed from translucent or opaque material, is shown in FIG. 4B.

FIG. 5A shows an arrangement of bricks 101, 103 in a stage side 501. Bricks 101, 103, for purposes of identification for data processing are designated with unique identifiers. In FIG. 5B, an exemplary arrangement of six sides 501a-f of stage 100 is illustrated. Also shown is the relationship between the sides 501a-f and the SBC's 503a-f. Each SBC 503a-f is responsive to a computer-based server 507. It will be noted in FIGS. 5A, 5B, SBC's 503 are shown as separate from their respective bricks 101, 103, but in an alternative embodiment, an SBC 503 could be housed within a brick along with a battery for power.

Different from light stages, polarized light sources are not used since the point of the system is not to capture skin detail. Furthermore, there is no hardware camera synchronization to reduce complexity. Advances in software-based synchronization and the high framerate of the cameras make this possible.

It will be appreciated by those skilled in the relevant arts with the benefit of this disclosure that the stage may be of larger scale to capture the interaction of bodies, human or robot, with larger objects. Indeed, a room-sized stage could be constructed of bricks 101, 103 according to the principles discussed above. Further, bricks 101 may be placed on a robot to provide the point of view from the robot's perspective. In this case, bricks 101 could advantageously include accelerometers.

Those skilled in the relevant arts will appreciate that the positioning of the cameras must be taken into account in processing the data. Camera calibration is a long-standing problem that provides intrinsic and extrinsic values of camera positions. Accurate intrinsic and extrinsic values are essential for 3D reconstruction and visual localization.

Each camera has intrinsic parameters that describe its internal characteristics, such as focal length, principal point (optical center), and lens distortion. These parameters are typically determined by calibration procedures provided by the camera manufacturer or through software calibration routines. Intrinsic parameters, for example, may be obtained by obtaining a set of images of a known calibration pattern, such as a checkerboard or a calibration grid, captured from different viewpoints. A Structure-from-Motion software, such as COLMAP, can then use these images to estimate the camera's intrinsic parameters. This information allows for accurate camera pose estimation and point cloud triangulation.

Extrinsic parameters define the position and orientation of each camera in 3D space relative to a common coordinate system. These parameters are usually determined through a calibration process where a known pattern, like a checkerboard, on one or more fiducial markers may be placed in the capture volume and captured by all cameras simultaneously. The 3D points of the pattern are then reconstructed using the 2D image points, allowing the system to calculate the camera's position and orientation. Once the cameras are calibrated, triangulation techniques can be used to determine the 3D positions of the markers in the capture volume. By combining the 2D image coordinates of the markers from multiple cameras with their corresponding camera extrinsic parameters, the system can calculate the 3D position of each marker.

Although this is a standard way of calibration, installing the checkerboards every for each scenario uninstalling afterwards requires a lot of extra effort. Also, manually installing of the markers generates undesirable noise in the process. Classical camera calibration relies on known structures in 3D. The well-known direct linear transformation (“DLT”) requires 2D-3D pairs. Other methods use predefined checkerboard structures. For example, see Zhengyou Zhang, “A Flexible New Technique for Camera Calibration,” IEEE Transactions on pattern analysis and machine intelligence, 22(11):1330-1334, 2000. SfM is widely used for calibration purposes, since SfM jointly estimate the camera poses (position and orientation) and 3D points. In contrast to SfM, Multi-View Stereo (MVS) aims to densely reconstruct the scene. However, MVS requires the known camera poses from SfM. Recently, rising amount of single-image-to-3D techniques has been proposed. Although they produce 3D structures from images only, they are not able to globally align different views for camera calibration.

The system described herein uses a novel technique of camera calibration without markers. First, pairs of input images are obtained. Given the N input images {I¹, . . . , I^{N}}, the scene graph consists of vertices v, i.e., the images, and edges e=(Iⁿ, I^{m}), i.e., the connected image pairs. A complete graph, obtained using the software DUST3R, provides a set of edges, E, given by,

$$E = \{ ( n , m ) \vert n , m ϵ \{ 1 , ... , N \} , n \neq m \}$$

Then, each pair is provided to a Vision Transformer (“ViT”) model-based, data-driven, supervision-trained neural network, such as Network F, proposed by Dosovitskiy, et al., in “An Image is Worth 16×16 Words: Transformers For Image Recognition At Scale.” arXiv preprint arXiv: 2010.11929, 2020. The PointMap data structure, Xᵢ^{V}, and the confidence map, Cᵢ^{V}, can then be estimated. PointMap represents the 3D point location of each pixel i∈{1, . . . , HW}. PointMap differs from depth in that it is expressed in the reference coordinate frame.

If only one pair is given, the well-established Perspective-n-Point with Random Sample Consensus (“PnP-RANSAC”) may be used to estimate camera poses Pₑ, but this is not applicable for multiple pairs due to the ill-posed scales de. Global alignment for all pairs is obtained by directly using the estimated PointMap for optimization, rejecting the reprojection error of the Bundle Adjustment for efficiency, the alignment given by

$${X}^{*} = arg min {\sum }_{e ∈ ε} {\sum }_{v ∈ e} {\sum }_{i = 1} {C}_{i}^{v} ‖ {X}_{i}^{v} - {σ}_{e} {P}_{e} {X}_{i}^{v} ‖$$

where X denotes the globally aligned PointMap. After the extrinsic parameter values and the PointMap are obtained, intrinsic parameter values are readily computed using perspective geometry.

It should be noted that the complete graph obtained from DUST3R defines the number of image pairs as O(N²). This leads to rapidly growing computational costs by the number of images during global optimization. The system described herein may require up to about 100 cameras, depending on the size of the capture volume. Thus, to be more cost-effective with limited resources, a shifted window scenegraph of window size, w, may be used, given by

$$ℰ = \{ ( n , m ) \vert n , m ∈ \{ 1 , … , N \} , 0 < ( ( m - n + N ) mod N ) < w \} .$$

The various cameras must be synchronized. While there exist sophisticated and costly systems with synchronization, these systems are custom-made. One objective of this system is to use off-the-shelf components. Accordingly, post-processing software executed by the system performs synchronization of the various camera streams.

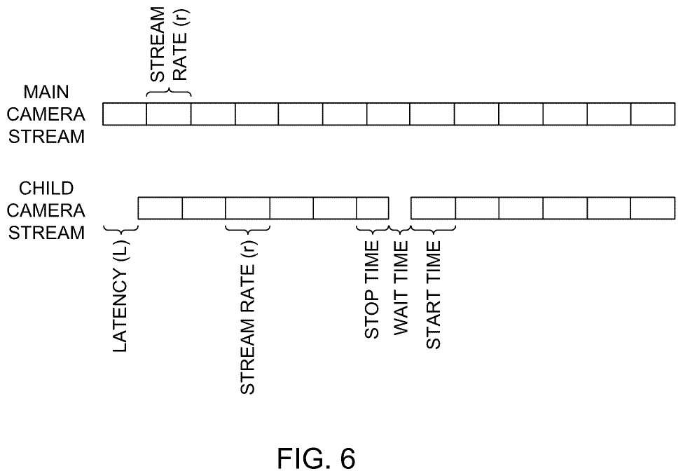

With reference to FIG. 6, camera stream synchronization algorithm assumes there are at least two streams: a main camera stream and child camera stream, that describe the primary camera stream and the secondary stream(s) to be synchronized with the main camera stream. Each rectangular box (r) indicates that time elapsed between two frames captured by a camera. L, indicates the latency or offset between the streams that needs to be eliminated.

The algorithm is based on the insight that if the child stream can be stopped for an appropriate duration and restarted after, the child camera stream may be brought into sync with the main camera streams. There are two unknowns here: the camera stop time (C₁) and the camera start time (C₂). Our algorithm introduces a wait time (W) that is inserted when the camera is stopped, but before it is started. W is given by the following equation:

$$W = r - mod ( L + {C}_{1} + {C}_{2} , r )$$

Delaying restart of the child camera stream some time, W, brings the streams into synchronization.

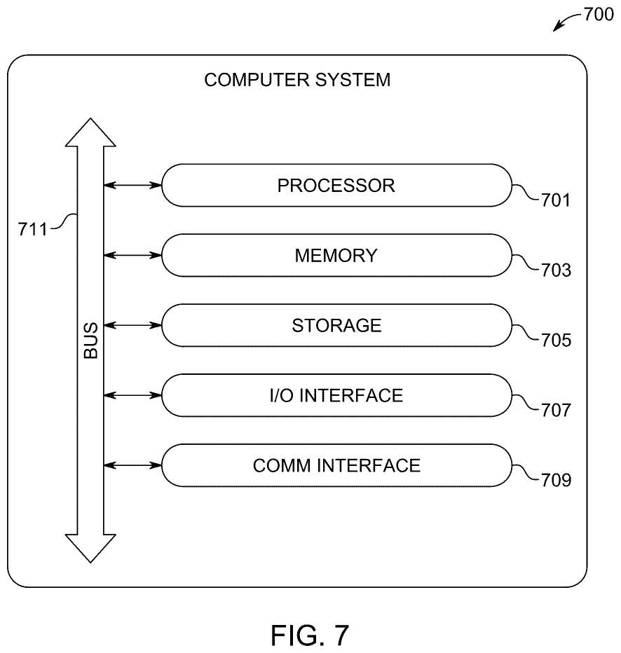

FIG. 7 illustrates an example computer system 700. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 701, memory 703, storage 705, an input/output (I/O) interface 707, a communication interface 709, and a bus 711. Although this disclosure describes and illustrates a particular computer system having a particular number of particular components in a particular arrangement, this disclosure contemplates any suitable computer system having any suitable number of any suitable components in any suitable arrangement.

In particular embodiments, processor 701 includes hardware for executing instructions, such as those making up a computer program. As an example and not by way of limitation, to execute instructions, processor 701 may retrieve (or fetch) the instructions from an internal register, an internal cache, memory 703, or storage 705; decode and execute them; and then write one or more results to an internal register, an internal cache, memory 703, or storage 705. In particular embodiments, processor 701 may include one or more internal caches for data, instructions, or addresses. This disclosure contemplates processor 701 including any suitable number of any suitable internal caches, where appropriate. As an example and not by way of limitation, processor 701 may include one or more instruction caches, one or more data caches, and one or more translation lookaside buffers (TLBs). Instructions in the instruction caches may be copies of instructions in memory 703 or storage 705, and the instruction caches may speed up retrieval of those instructions by processor 701. Data in the data caches may be copies of data in memory 703 or storage 705 for instructions executing at processor 701 to operate on; the results of previous instructions executed at processor 701 for access by subsequent instructions executing at processor 701 or for writing to memory 703 or storage 705; or other suitable data. The data caches may speed up read or write operations by processor 701. The TLBs may speed up virtual-address translation for processor 701. In particular embodiments, processor 701 may include one or more internal registers for data, instructions, or addresses. This disclosure contemplates processor 701 including any suitable number of any suitable internal registers, where appropriate. Where appropriate, processor 701 may include one or more arithmetic logic units (ALUs); be a multi-core processor; or include one or more processors 701. Although this disclosure describes and illustrates a particular processor, this disclosure contemplates any suitable processor.

In particular embodiments, memory 703 includes main memory for storing instructions for processor 701 to execute or storing data for processor 701 to operate on. As an example and not by way of limitation, computer system 700 may load instructions from storage 705 or another source (such as, for example, another computer system 700) to memory 703. Processor 701 may then load the instructions from memory 703 to an internal register or internal cache. To execute the instructions, processor 701 may retrieve the instructions from the internal register or internal cache and decode them. During or after execution of the instructions, processor 701 may write one or more results (which may be intermediate or final results) to the internal register or internal cache. Processor 701 may then write one or more of those results to memory 703. In particular embodiments, processor 701 executes only instructions in one or more internal registers or internal caches or in memory 703 (as opposed to storage 705 or elsewhere) and operates only on data in one or more internal registers or internal caches or in memory 703 (as opposed to storage 705 or elsewhere). One or more memory buses (which may each include an address bus and a data bus) may couple processor 701 to memory 703. Bus 711 may include one or more memory buses, as described below. In particular embodiments, one or more memory management units (MMUs) reside between processor 701 and memory 703 and facilitate accesses to memory 703 requested by processor 701. In particular embodiments, memory 703 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 703 may include one or more memories 704, where appropriate. Although this disclosure describes and illustrates particular memory, this disclosure contemplates any suitable memory.

In particular embodiments, storage 705 includes mass storage for data or instructions. As an example, and not by way of limitation, storage 705 may include a hard disk drive (HDD), a floppy disk drive, flash memory, an optical disc, a magneto-optical disc, magnetic tape, or a Universal Serial Bus (USB) drive or a combination of two or more of these. Storage 705 may include removable or non-removable (or fixed) media, where appropriate. Storage 705 may be internal or external to computer system 700, where appropriate. In particular embodiments, storage 705 is non-volatile, solid-state memory. In particular embodiments, storage 705 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 705 taking any suitable physical form. Storage 705 may include one or more storage control units facilitating communication between processor 701 and storage 705, where appropriate. Where appropriate, storage 705 may include one or more storages 705. Although this disclosure describes and illustrates particular storage, this disclosure contemplates any suitable storage.

In particular embodiments, I/O interface 707 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 707 for them. Where appropriate, I/O interface 707 may include one or more device or software drivers enabling processor 701 to drive one or more of these I/O devices. I/O interface 707 may include one or more I/O interfaces 707, where appropriate. Although this disclosure describes and illustrates a particular I/O interface, this disclosure contemplates any suitable I/O interface.

In particular embodiments, communication interface 709 includes hardware, software, or both providing one or more interfaces for communication (such as, for example, packet-based communication) between computer system 700 and one or more other computer systems 700 or one or more networks. As an example and not by way of limitation, communication interface 709 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 709 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 709 for any of these networks, where appropriate. Communication interface 709 may include one or more communication interfaces 709, where appropriate. Although this disclosure describes and illustrates a particular communication interface, this disclosure contemplates any suitable communication interface.

In particular embodiments, bus 711 includes hardware, software, or both coupling components of computer system 700 to each other. As an example and not by way of limitation, bus 711 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 711 may include one or more buses 312, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

As described above and shown in the associated drawings, the present invention comprises a system for spatiotemporal audiovisual capture. While particular embodiments have been described, it will be understood, however, that any invention appertaining to the system described is not limited thereto, since modifications may be made by those skilled in the art, particularly in light of the foregoing teachings. It is, therefore, contemplated by the appended claims to cover any such modifications that incorporate those features or those improvements that embody the spirit and scope of the invention.

What is claimed is:

1. A system for data capture comprising:
a stage comprising a multi-sided stage frame, said stage frame defining a stage chamber;
a plurality of first sensor modules mounted to said frame, each said first sensor modules comprising:
a module frame having a front side toward said chamber and a back side toward an exterior of said stage;
a translucent front panel attached to said front side of said module frame, said front panel comprising an RGB camera, a depth camera, an IR camera, and a microphone;
a back panel attached to said back side of said module frame, said back panel supporting a lighting array; and
a plurality of second sensor modules mounted to said stage frame, each said second sensor module comprising:
an elongated frame having a front side toward said chamber and a back side toward the exterior of said stage; and
a translucent elongated front panel attached to said front side of said elongated frame, said elongated front panel comprising at least one RGB camera.

2. The system of claim 1, further comprising a computer-based device to which the RGB camera, depth camera, IR camera, and the microphone are responsive.

3. The system of claim 2, further comprising a computer-based server to which the computer-based device is responsive.

4. The system of claim 1, wherein each of the first and second sensor modules is associated with a computer-based device in communication with the RGB camera, depth camera, IR camera, and the microphone.

5. The system of claim 4, further comprising a computer-based server to which each computer-based device is responsive.

6. A system for 3D and 4D data capture comprising:
a plurality of sensor modules, each said sensor modules comprising:
an RGB camera, a depth camera, an IR camera, a microphone, and a non-polarized light source.

7. The system of claim 6, wherein each sensor module further comprises a computer-based device for controlling the RGB camera, the depth camera, the IR camera, the microphone, and the non-polarized light source.

8. The system of claim 7, further comprising a computer-based server in communication with each computer-based device.

9. The system of claim 6, further comprising:
a stage frame for supporting the plurality of sensor modules, the stage frame defining a capture volume.

10. The system of claim 9, wherein the stage frame is transportable.

11. The system of claim 6, wherein at least one of the plurality of sensor modules is mounted to an actor, the actor being a human or a robot.

12. The system of claim 11, further comprising:
a stage frame for supporting the plurality of sensor modules, the stage frame defining a capture volume.

13. The system of claim 9, wherein the stage frame is transportable.

14. The system of claim 11, wherein each sensor module further comprises a computer-based device for controlling the RGB camera, the depth camera, the IR camera, the microphone, and the non-polarized light source.

15. The system of claim 14, further comprising a computer-based server in communication with each computer-based device.
